(19) United States
(12) Patent Application Publication
(10) Pub. No.: US 2009/0283389 A1
(43) Pub. Date: Nov. 19, 2009

(54) BATTERY SAVING CIRCUIT

(75) Inventors: Wilson Nogueira Da Silva, Sao Paolo (BR); Cesar Venancio, Sao Bernardo do Campo (BR); Elias Gomes De Oliveira, Sao Paulo (BR)

Correspondence Address: ROBERT J. KAPALKA;TYCO TECHNOLOGY RESOURCES, 4550 NEW LINDEN HILL ROAD, SUITE 140, WILMINGTON, DE, 19808, US

(73) Assignee: TYCO ELECTRONICS BRASIL LTDA, Sao Paulo (BR)

(21) Appl. No.: 12/122,335

(22) Filed: May 16, 2008

(51) Int. Cl. H01H 3/16

(52) U.S. Cl. 200/61.58 R

(57) ABSTRACT

A battery saving circuit is provided for protecting and maintaining the charge within a battery of a vehicle. The vehicle includes a power source, a battery, a plurality of electrical loads, and an ignition switch that includes an off position wherein the power source is not operating. The battery saving circuit includes at least one save switch configured to be electrically connected between the battery and a sub-set of the plurality of electrical loads of the vehicle. The at least one switch is operatively connected to the ignition switch of the vehicle such that the sub-set of electrical loads are always electrically disconnected from the battery when the ignition switch is in the off position.

### BACKGROUND OF THE INVENTION

This invention relates generally to vehicle batteries, and more particularly, to a battery saving circuit for protecting and maintaining the charge within a vehicle battery.

Many vehicles include a battery for powering various electrical loads of the vehicle. For example, many cars, trucks, marine, vessels, aircraft, and the like include a battery. The battery may power ignition of a power source of the vehicle, such as an engine, and/or may power hazard lights, a dome light, a radio, running lights, an alarm, a clock, a cigarette lighter plug, the like, and/or the memories of electrical devices of the vehicle, such as radio, clock, seat position memories, and/or the like.

Sometimes, even when the power source of a vehicle is shutoff, the battery may drain and therefore lose overall capacity. Drainage of the battery when the power source is shutoff may be caused by inadvertently turning or leaving on an electrical device of the vehicle that is available when the ignition switch of the vehicle is in an “off” position wherein the power source of the vehicle is shutoff. For example, a driver of a car may leave the headlights on and/or the driver or a passenger of the car may leave the radio running after the car's engine is shutoff. Leaving the key of a vehicle in a position wherein the ignition switch is off but some electrical devices are supplied power by, and/or are available to receive power from, the battery may also drain capacity from the battery. Moreover, electrical memories and other electrical devices that require intermittent or continuous electrical power even when the power source of the vehicle is off may drain the battery over time. Even vehicles that include alternators or generators that recharge the battery during operation of the vehicle's power source may experience battery drain when the power source is not operated for a length of time, e.g., during transit and/or storage between manufacture and sale of the vehicle. Drainage of the battery of a vehicle, for example as described above, may cause malfunction of the vehicle. For example, the battery of the vehicle may drain sufficiently such that a power source of the vehicle will not start and/or other electrical devices of the vehicle may not operate.

Some known systems that facilitate protecting against battery drainage include a safety circuit that disconnects all of the electrical loads of the vehicle from the battery when the vehicle's power source is shutoff. For example, the safety circuit may be wired between the battery and a starter motor and a fuse box of the vehicle such that power is supplied to the starter motor and the fuse box only once the vehicle's ignition switch is turned to an “on” position wherein the vehicle's power source is operating. However, to accommodate disconnecting all of the electrical loads of a vehicle from the battery, such safety circuits may use relays that are designed to handle the entire voltage (e.g., approximately 12 Volts) of the battery. Relays designed to handle the entire voltage of the vehicle battery may be more expensive and/or larger in size, which may increase a cost and/or complexity of the safety circuit and/or may limit the space for other components.

There is a need for a circuit that facilitates protecting and maintaining the charge within a vehicle battery using less expensive and/or smaller relays.

### BRIEF DESCRIPTION OF THE INVENTION

In one embodiment, a battery saving circuit is provided for protecting and maintaining the charge within a battery of a vehicle. The vehicle includes a power source, a battery, a plurality of electrical loads, and an ignition switch that includes an off position wherein the power source is not operating. The battery saving circuit includes at least one save switch configured to be electrically connected between the battery and a sub-set of the plurality of electrical loads of the vehicle. The at least one switch is operatively connected to the ignition switch of the vehicle such that the sub-set of electrical loads are always electrically disconnected from the battery when the ignition switch is in the off position.

In another embodiment, an electrical system is provided for a vehicle having a power source and a plurality of electrical loads. The system includes a battery, an ignition switch operatively connected to the battery and an ignition system of the power source for selectively turning the ignition system of the power source on and off. The ignition switch has an off position wherein the power source is not operating. The electrical system also includes a battery saving circuit for protecting and maintaining a charge within the battery. The battery saving circuit is electrically connected between the battery and a sub-set of the plurality of electrical loads of the vehicle. The battery saving circuit is operatively connected to the ignition switch of the vehicle such that the sub-set of electrical loads are always electrically disconnected from the battery when the ignition switch is in the off position.

### BRIEF DESCRIPTION OF THE DRAWINGS

FIG. 1 is a schematic diagram of an exemplary electrical system for a vehicle illustrating an exemplary embodiment of a battery saving circuit for protecting and maintaining the charge within a battery of the electrical system.

FIG. 2 is a schematic diagram of an exemplary electrical system for a vehicle illustrating another exemplary embodiment of a battery saving circuit.

FIG. 3 is a schematic diagram of another exemplary electrical system for an exemplary vehicle.

FIG. 4 is a partially broken away perspective view of an exemplary embodiment of a battery saving circuit of the electrical system shown in FIG. 3.

FIG. 5 is a perspective view illustrating the battery saving circuit shown in FIG. 4 electrically connected to a fuse box of the electrical system shown in FIG. 3.

### DETAILED DESCRIPTION OF THE INVENTION

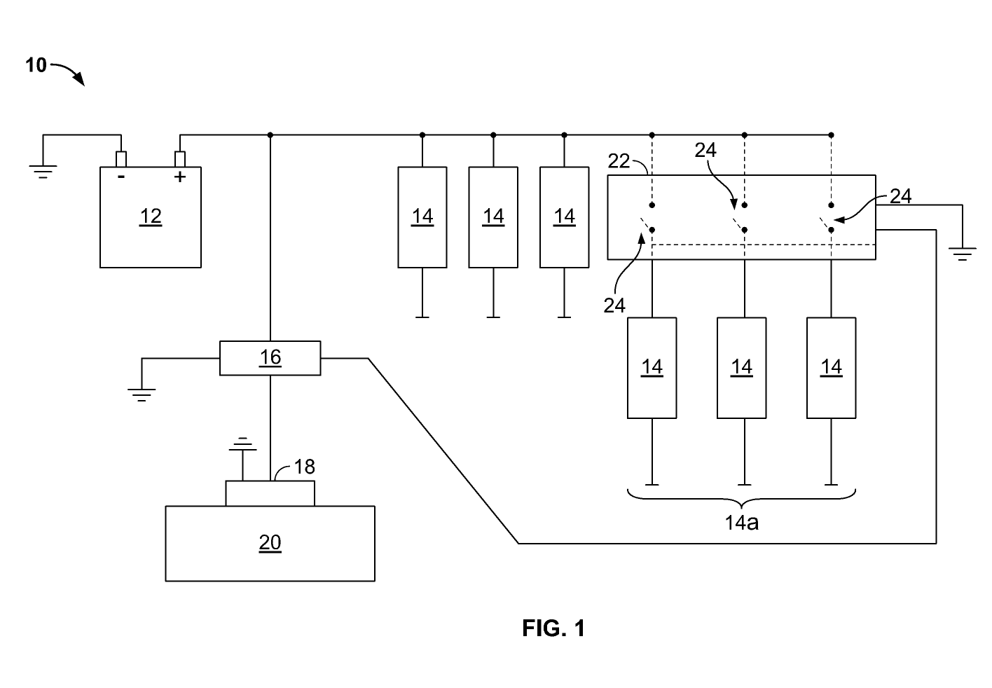

FIG. 1 is a schematic diagram of an exemplary electrical system 10 for a vehicle (not shown). The electrical system 10 includes a battery 12 and a plurality of electrical loads 14 that are electrically connected to, and therefore powered by, the battery 12. An ignition switch 16 is operatively connected to the battery 12 and an ignition system 18 of a power source 20 of the vehicle for selectively turning the ignition system 18 on and off. Specifically, the ignition switch 16 is electrically connected between the battery 12 and the ignition system 18 and is selectable between an off position and an on position. In the off position, the ignition switch 16 is open such that the ignition system 18 of the power source 20 is not supplied with electrical power from the battery 12 and is therefore not operating (referred to herein as “off”). Accordingly, when the ignition switch 16 is in the off position, the power source 20 is not operating. In the on position, the ignition switch 16 is closed such that the ignition system 18 of the power source 20 is supplied with electrical power from the battery 12 and is therefore operating (referred to herein as “on”). Accordingly, when the ignition switch 16 is in the on position, the power source 20 may be operating. In some embodiments, an actuation component (such as, but not limited to, a key, a toggle lever, and/or the like) of the vehicle that actuates the ignition switch 16 between the off and on positions may have a position (referred to herein as an “intermediate position”) wherein the ignition switch is off but some of the electrical loads 14 are supplied, and/or are available to receive, electrical power from the battery 12.

The electrical system 10 also includes a battery saving circuit 22 for protecting and maintaining the charge within the battery 12. The battery saving circuit 22 is electrically connected between the battery 12 and a sub-set 14a of the electrical loads 14 of the vehicle to selectively electrically connect and disconnect the sub-set 14a of electrical loads 14 from the battery 12. Specifically, in the exemplary embodiment of FIG. 1, the battery saving circuit 22 includes a plurality of switches 24 that can be closed and opened to electrically connect and disconnect, respectively, the subset 14a of electrical loads 14 from the battery 12. Each of the switches 24 may be referred to herein as a “save switch”. In the exemplary embodiment of FIG. 1, the battery saving circuit 22 includes a plurality of the switches 24, wherein each switch corresponds to a different electrical load 14 of the sub-set 14a of electrical loads 14. Specifically, each switch 24 is electrically connected between the corresponding electrical load 14 and the battery 12 for electrically connecting and disconnecting the corresponding electrical load 14 from the battery 12. Alternatively, one or more of the switches 24 may be electrically connected between the battery 12 and more than one electrical load 14 of the sub-set 14a such that a single switch 24 electrically connects and disconnects more than one electrical load 14 of the sub-set 14a. Moreover, in another alternative embodiment, the battery saving circuit 22 includes only one switch 24 that is electrically connected between the battery 12 and all of the electrical loads 14 of the sub-set 14a such that a single switch 24 electrically connects and disconnects all of the electrical loads 14 of the sub-set 14a from the battery 12.

The battery saving circuit 22 is operatively connected to the ignition switch 16 such that selection of the ignition switch 16 between the off and on positions electrically connects and disconnects the sub-set 14a of electrical loads 14 from the battery 12. The battery saving circuit 22 may be operatively connected to the ignition switch 16 using any suitable method, configuration, arrangement, means, structure, and/or the like that enables the battery saving circuit 22 to electrically connect and disconnect the sub-set 14a of electrical loads 14 from the battery 12 based on the position of the ignition switch 16. In the exemplary embodiment of FIG. 1, the ignition switch 16 is electrically connected between the battery 12 and the battery saving circuit 22 such that when the ignition switch 16 is in the on position, the battery saving circuit 22 receives electrical power from the battery 12 via the ignition switch 16. Similarly, when the ignition switch 16 is in the off position, the battery saving circuit 22 does not receive electrical power from the battery 12 via the ignition switch 16. The exemplary switches 24 of the embodiment of FIG. 1 are relays that are electrically connected to the battery 12 via the ignition switch 16 when the ignition switch 16 is in the on position. In operation, the switches 24 are biased to an open position wherein the sub-set 14a of electrical loads 14 are electrically disconnected from the battery 12. When the ignition switch 16 is moved from the off position to the on position, the switches 24 receive electrical power from the battery 12 via the ignition switch 16 such that the switches 24 are energized to move from the open position to a closed position against the bias. Accordingly, when the ignition switch 16 is in the off position the switches 24 are open such that the sub-set 14a of electrical loads 14 are always (when the ignition switch 16 is in the off position) disconnected from the battery 12. When the ignition switch is in the on position, the switches 24 are closed and the sub-set 14a of electrical loads 14 are electrically connected to the battery 12. Although the switches 24 are shown in FIG. 1 as being electrically connected to the ignition switch 16 in series, the switches 24 may alternatively be electrically connected to the ignition switch 16 in parallel, or in some combination of parallel and series.

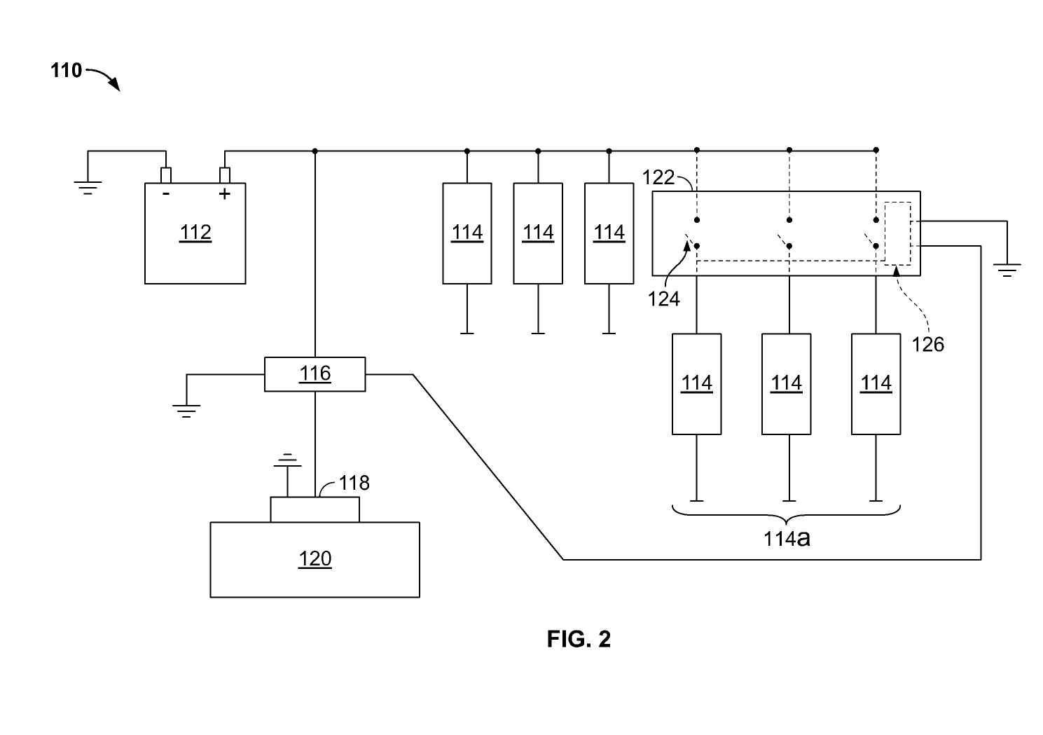

In another embodiment, the battery saving circuit 22 includes a controller (not shown in FIG. 1) that opens and closes the switches 24 based on an electrical signal received from the ignition switch 16 that indicates whether the ignition switch is in the on position. For example, FIG. 2 is a schematic diagram of an exemplary electrical system 110 for a vehicle illustrating another exemplary embodiment of a battery saving circuit 122. The electrical system 110 includes a battery 112 and a plurality of electrical loads 114 that are electrically connected to, and therefore powered by, the battery 112. An ignition switch 116 is operatively connected to the battery 112 and an ignition system 118 of a power source 120 of the vehicle for selectively turning the ignition system 118 on and off.

The battery saving circuit 122 includes a plurality of switches 124 that can be closed and opened to electrically connect and disconnect, respectively, the subset 114a of electrical loads 114 from the battery 112. Each of the switches 124 may be referred to herein as a “save switch”. The battery saving circuit 122 is operatively connected to the ignition switch 116 such that selection of the ignition switch 116 between the off and on positions electrically connects and disconnects the sub-set 114a of electrical loads 114 from the battery 112. In the exemplary embodiment of FIG. 2, the battery saving circuit 122 includes a controller 126 that is operatively connected to the switches 124 for opening and closing the switches 124. The controller 126 receives one or more electrical signals from the ignition switch 116 that indicates whether the ignition switch 116 is on and/or off. The electrical signal(s) may be sent to the controller 126 when the ignition switch 116 is moved from the off position to the on position and/or when the ignition switch 116 is moved from the on position to the off position. Moreover, the electrical signal(s) may be maintained while the ignition switch 116 is on and/or while the ignition switch 116 is off. Based on the electrical signal(s), the controller 126 closes the switches 124 when the ignition switch 116 is on and opens the switches 124 when the ignition switch 116 is off. The switches 124 may be relays or another type of switch. If the switches 124 are relays, energization of the switches 124 to move between the open and closed positions may be provided directly from the battery 112, from the controller 126, and/or via the ignition switch 116 as in the embodiment of FIG. 1. Moreover, the controller 126 may open and close the switches 124 using any suitable method, structure, configuration, arrangement, means, and/or the like (whether mechanical and/or electrical) that enables the battery saving circuit 122 to function as described herein. Although the switches 124 are shown in FIG. 2 as being electrically connected to the controller 126 in series, the switches 124 may alternatively be electrically connected to the controller 126 in parallel, or in some combination of parallel and series.

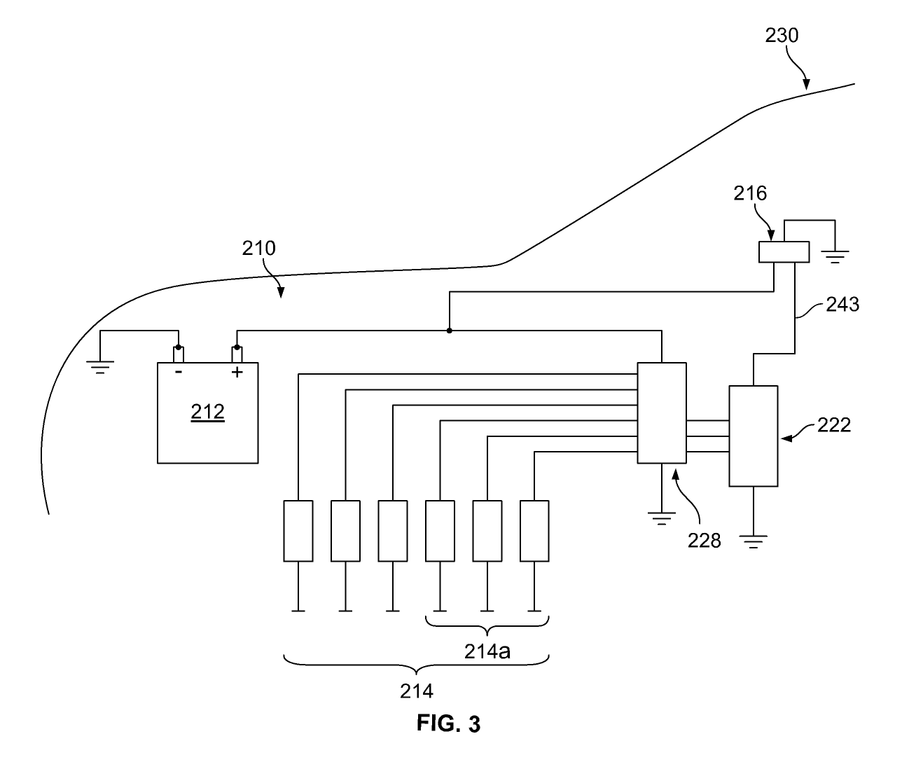

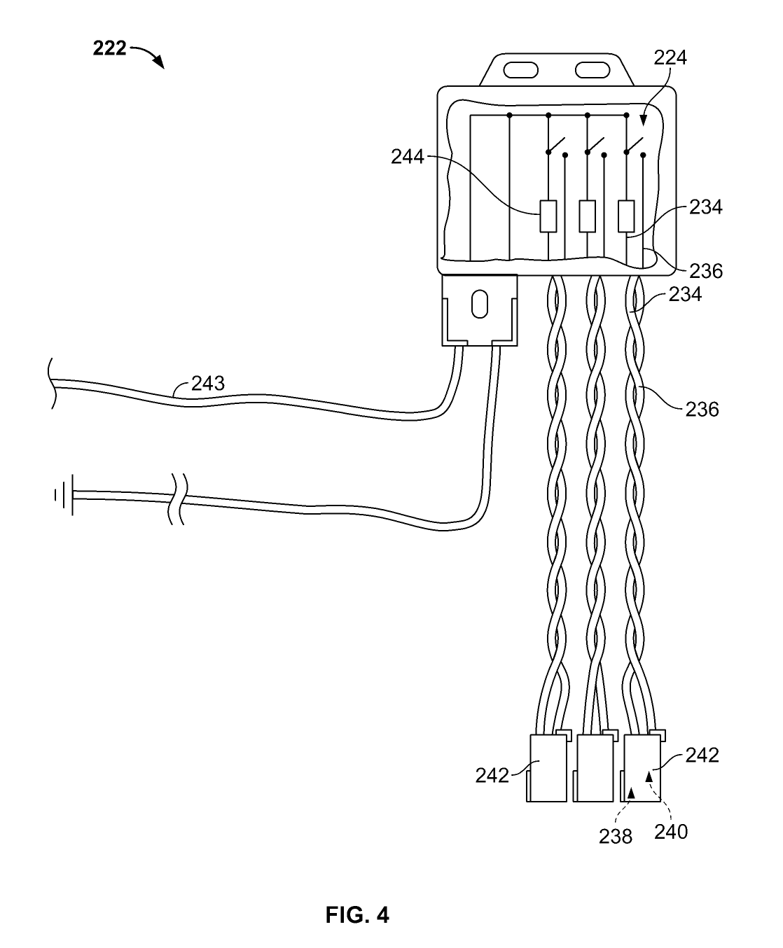

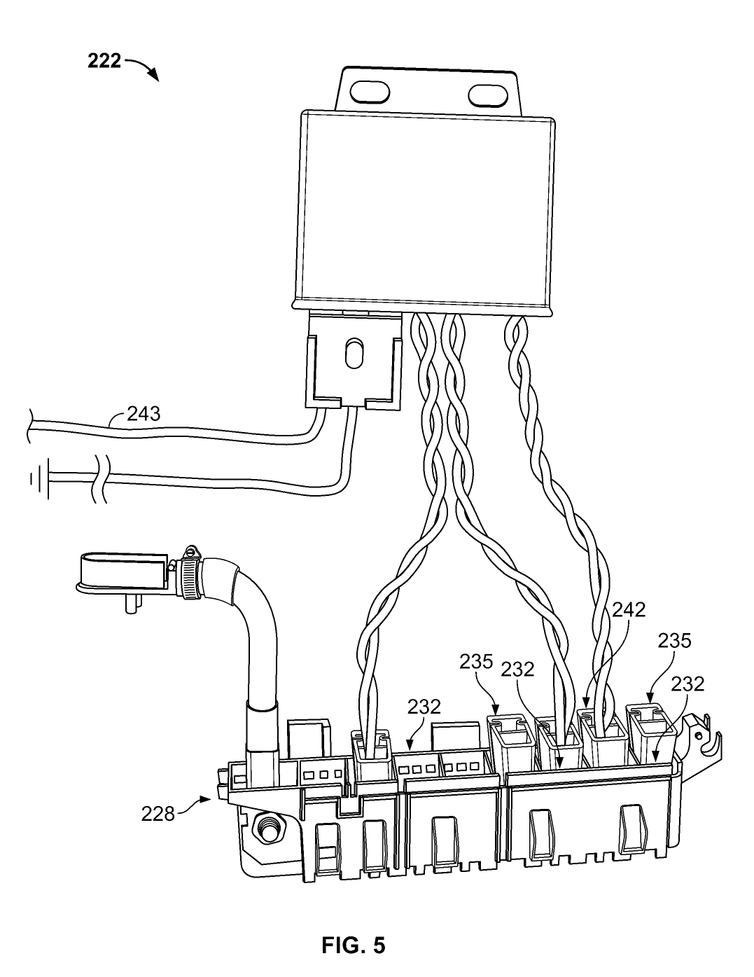

The battery saving circuit embodiments described and illustrated herein may optionally be used in combination with a fuse box of a vehicle. For example, FIGS. 3-5 illustrate an embodiment wherein a battery saving circuit 222 is used in combination with an exemplary fuse box 228 of an exemplary vehicle 230. Specifically, FIG. 3 is a schematic diagram of an exemplary electrical system 210 for the vehicle 230; FIG. 4 is a partially broken away perspective view of an exemplary embodiment of the battery saving circuit 222; and FIG. 5 is a perspective view illustrating the battery saving circuit 222 electrically connected to the fuse box 228. The electrical system 210 includes a battery 212, the fuse box 228, and a plurality of electrical loads 214 that are electrically connected to the battery 212 via the fuse box 228. An ignition switch 216 is operatively connected to the battery 212 and an ignition system (not shown) of a power source (not shown) of the vehicle 230 for selectively turning the ignition system on and off. The fuse box 228 includes a plurality of receptacles 232 that each includes two electrical contacts (not shown). One of the electrical contacts within each receptacle 232 is electrically connected to the battery 212 while the other electrical contact is electrically connected to a corresponding one of the electrical loads 214. Each of the receptacles 232 receives a fuse 235 therein that electrically connects the two electrical contacts. Some of the receptacles are shown in FIG. 5 without a fuse 235 therein for clarity.

The battery saving circuit 222 includes a plurality of switches 224 that can be closed and opened to electrically connect and disconnect, respectively, a subset 214a of electrical loads 214 from the battery 212. Each of the switches 224 may be referred to herein as a “save switch”. To electrically connect the battery saving circuit 222 between the battery 212 and the sub-set 214a of the electrical loads 214, the battery saving circuit 222 is electrically connected to the fuse box 228. Specifically, each switch 224 of the battery saving circuit 222 includes an electrical input 234 and an electrical output 236. End portions 238 and 240 of the electrical inputs and outputs 234 and 236, respectively, of each of the switches 224 are held by a housing 242. The housings 242 are each sized and shaped similar to the fuses 235 such that each of the housings 242 are configured to be received within one of the receptacles 232 that receives the fuses 235. The fuses 235 that correspond to the sub-set 214a of electrical loads can therefore be removed from the fuse box 228 and replaced by one of the housings 242. When a housing 242 is received within a receptacle 232, the end portion 238 of the electrical input 234 of the corresponding switch 224 is electrically connected to the electrical contact of the receptacle 232 that is electrically connected to the battery 212, while the end portion 240 of the electrical output 236 of the corresponding switch 224 is electrically connected to the electrical contact of the receptacle that is electrically connected to the corresponding electrical load 214 of the sub-set 214a. Accordingly, the battery saving circuit can be electrically connected between the battery 212 and the sub-set 214a of the electrical loads 214 by replacing the fuses 235 of the sub-set 214a with the housings 242. Each switch 224 may optionally include a fuse 244 to accommodate the loss of the replaced fuse 235. Although shown as being positioned along the electrical input 234 of each switch 224 between the switch 224 and the end portion 238, the fuses 244 may be positioned anywhere along the electrical input 234, anywhere else on the switch 244, and/or anywhere else within the battery saving circuit 222 that enables the fuse 244 to function substantially similar to the fuses 235.

As shown by the reference numeral 243, the battery saving circuit 222 is electrically connected to the ignition switch 216. The battery saving circuit 222 is operatively connected to the ignition switch 216 such that selection of the ignition switch 216 between the off and on positions electrically connects and disconnects the sub-set 214a of electrical loads 214 from the battery 212. Specifically, similar to the embodiment of FIG. 1, the ignition switch 216 is electrically connected between the battery 212 and the battery saving circuit 222 such that when the ignition switch 216 is in the on position, the battery saving circuit 222 receives electrical power from the battery 212 via the ignition switch 216. Similarly, when the ignition switch 216 is in the off position, the battery saving circuit 222 does not receive electrical power from the battery 212 via the ignition switch 216. The exemplary switches 224 of the embodiment of FIGS. 3-5 are relays that are electrically connected to the battery 212 via the ignition switch 216 when the ignition switch 216 is in the on position. In operation, the switches 224 are biased to an open position wherein the sub-set 214a of the electrical loads 214 are electrically disconnected from the battery 212. When the ignition switch 216 is moved from the off position to the on position, the switches 224 receive electrical power from the battery 212 via the ignition switch 216 such that the switches 224 are energized to move from the open position to a closed position against the bias. Accordingly, when the ignition switch 216 is in the off position the switches 224 are open such that the sub-set 214a of the electrical loads 14 are always (when the ignition switch 216 is in the off position) disconnected from the battery 212. When the ignition switch is in the on position, the switches 224 are closed and the sub-set 214a of the electrical loads 214 are electrically connected to the battery 212. Electrical connection between the battery saving circuit 222 and the ignition switch 216 is indicated by the reference numeral 243.

Although six electrical loads 14, 114, or 214 are shown in each of the embodiments described and illustrated herein, each vehicle may include any number of electrical loads 14, 114, or 214, whether or not some or all of the loads are electrically connected to a battery via a fuse box. Moreover, although each sub-set 14a, 114a, and 214a is shown having three electrical loads 14, 114, and 214, respectively, each sub-set 14, 114a, and 214a may include any number of electrical loads, whether or not some or all of the loads are electrically connected to a battery via a fuse box.

The sub-sets 14a, 114a, and 214a of the respective electrical loads 14, 114, and 214 may be selected as any sub-combination of the respective electrical loads 14, 114, and 214. For example, one or more loads 14, 114, and/or 214 of each respective sub-set 14a, 114a, and/or 214a may be selected as a load that, without the respective battery saving circuit 22, 122, or 222, would use intermittent or continuous electrical power from the respective battery 12, 112, and 212 when the respective ignition switch 16, 116, and 216 is in the off position. Moreover, and for example, one or more loads 14, 114, and/or 214 of each respective sub-set 14a, 114a, and/or 214a may be selected as a load that, without the respective battery saving circuit 22, 122, or 222, would be available to receive electrical power from the respective battery 12, 112, and 212 when the respective ignition switch 16, 116, and 216 is in the off position (such as, but not limited to, loads that are supplied, and/or are available to receive, electrical power from the battery 12, 112, or 212 when an actuation component of the vehicle that actuates the respective ignition switch 16, 116, and 216 between the off and on positions is in an intermediate position). Another example of one or more loads 14, 114, and/or 214 of each respective sub-set 14a, 114a, and/or 214a includes a load that draws below a predetermined voltage and/or current threshold, such as, but not limited to, between approximately 0 Amperes and approximately 150 Amperes. In some embodiments, one or more loads 14, 114, and/or 214 of each respective sub-set 14a, 114a, and/or 214a includes a load that draws between approximately 10 Amperes and approximately 60 Amperes. In some embodiments, one or more loads 14, 114, and/or 214 of each respective sub-set 14a, 114a, and/or 214a includes a load that draws between approximately 20 Amperes and approximately 40 Amperes.

The switches 24, 124, and 224 may each be any suitable type of switch that enables the switches 24, 124, and 224 to function as described herein, such as, but not limited to, a relay and/or the like. In some embodiments, one or more switches 24, 124, and/or 224 may have a rating of less than approximately 150 Amperes. In some embodiments, one or more switches 24, 124, and/or 224 may have a rating of less than approximately 60 Amperes. In some embodiments, one or more switches 24, 124, and/or 224 may have a rating of less than approximately 40 Amperes.

The batteries 12, 112, and 212 may each be any suitable type of battery having any suitable voltage and current capacity that enables the battery 12, 112, and 212 to function as intended for the particular vehicle the battery 12, 112, and 212 is used with. Moreover, the vehicles described and illustrated herein may each be any type of vehicle that includes a battery for powering one or more electrical loads, such as, but not limited to, cars, trucks, marine, vessels, aircraft, and/or the like.

The embodiments described herein provide a battery saving circuit that may facilitate protecting and maintaining a charge within a vehicle battery using less expensive, smaller, and/or lower rated switches. The battery saving circuit may optionally be installed in a vehicle prior to sale of the vehicle. For example, after manufacturing of the vehicle, the battery saving circuit may be installed in the vehicle to facilitate protecting and maintaining a charge within the vehicle battery during storage and/or transport of the vehicle to a place of sale. Once the vehicle has been sold, the battery saving circuit may optionally be removed (for example from the battery saving circuit may be removed from the vehicle's fuse box and replaced with conventional fuses) such that, when the ignition switch is off, the owner of the vehicle can use the sub-set of electrical loads that were originally isolated by the battery saving circuit.

Exemplary embodiments are described and/or illustrated herein in detail. The embodiments are not limited to the specific embodiments described herein, but rather, components and/or steps of each embodiment may be utilized independently and separately from other components and/or steps described herein. Each component, and/or each step of one embodiment, can also be used in combination with other components and/or steps of other embodiments. When introducing elements/components/etc. described and/or illustrated herein, the articles “a”, “an”, “the”, “said”, and “at least one” are intended to mean that there are one or more of the element(s)/component(s)/etc. The terms “comprising”, “including” and “having” are intended to be inclusive and mean that there may be additional element(s)/component(s)/etc. other than the listed element(s)/component(s)/etc. Moreover, the terms “first,” “second,” and “third,” etc. in the claims are used merely as labels, and are not intended to impose numerical requirements on their objects. Further, the limitations of the following claims are not written in means—plus-function format and are not intended to be interpreted based on 35 U.S.C. § 112, sixth paragraph, unless and until such claim limitations expressly use the phrase “means for” followed by a statement of function void of further structure.

While the invention has been described in terms of various specific embodiments, those skilled in the art will recognize that the invention can be practiced with modification within the spirit and scope of the claims.

What is claimed is:

1. A battery saving circuit for protecting and maintaining the charge within a battery of a vehicle, wherein the vehicle includes a power source, a battery, a plurality of electrical loads, and an ignition switch that includes an off position wherein the power source is not operating, said battery saving circuit comprising:
at least one save switch configured to be electrically connected between the battery and a sub-set of the plurality of electrical loads of the vehicle, the at least one switch being operatively connected to the ignition switch of the vehicle such that the sub-set of electrical loads are always electrically disconnected from the battery when the ignition switch is in the off position.

2. The battery saving circuit according to claim 1, wherein the sub-set of the plurality of electrical loads of the vehicle is a single electrical load.

3. The battery saving circuit according to claim 1, wherein the sub-set of the plurality of electrical loads of the vehicle comprises more than one electrical load, the at least one save switch comprising a plurality of save switches, each save switch corresponding to a different electrical load of the sub-set of electrical loads, each save switch being configured to be electrically connected between the corresponding electrical load and the battery for electrically connecting and disconnecting the electrical load from the battery.

4. The battery saving circuit according to claim 1, wherein the save switch comprises a rating of less than approximately 60 Amperes.

5. The battery saving circuit according to claim 1, wherein the save switch comprise a relay that is configured to be electrically connected to the ignition switch such that switching of the ignition switch from the off position to an on position energizes the relay to thereby close the save switch such that the at least one electrical load of the subset of electrical loads is electrically connected to the battery.

6. The battery saving circuit according to claim 1, further comprising a fuse configured to be electrically connected between the battery and at least one electrical load of the sub-set of electrical loads.

7. The battery saving circuit according to claim 1, wherein the vehicle further comprises a fuse box electrically connected between the battery and at least some of the plurality of electrical loads of the vehicle, wherein the save switch is configured to be electrically connected to the fuse box such that the battery saving circuit is electrically connected between the battery and the sub-set of the electrical loads of the vehicle.

8. The battery saving circuit according to claim 1, wherein the vehicle further comprises a fuse box electrically connected between the battery and at least some of the plurality of electrical loads of the vehicle, wherein the save switch comprises an electrical input and an electrical output that are configured to be electrically connected to the fuse box in place of a fuse such that the save switch is electrically connected between the battery and at least one electrical load of the sub-set of electrical loads for electrically connecting and disconnecting the at least one electrical load from the battery.

9. The battery saving circuit according to claim 1, wherein the sub-set of the plurality of electrical loads of the vehicle comprises an electrical load that, without the battery saving circuit, would use intermittent or continuous electrical power from the battery when the ignition switch is in the off position.

10. The battery saving circuit according to claim 1, wherein the sub-set of the plurality of electrical loads of the vehicle comprises an electrical load that, without the battery saving circuit, would be available to receive electrical power from the battery when the ignition switch is in the off position.

11. An electrical system for a vehicle having a power source and a plurality of electrical loads, said system comprising:
a battery;
an ignition switch operatively connected to the battery and an ignition system of the power source for selectively turning the ignition system of the power source on and off, the ignition switch having an off position wherein the power source is not operating;
a battery saving circuit for protecting and maintaining a charge within the battery, the battery saving circuit being electrically connected between the battery and a sub-set of the plurality of electrical loads of the vehicle, the battery saving circuit being operatively connected to the ignition switch of the vehicle such that the sub-set of electrical loads are always electrically disconnected from the battery when the ignition switch is in the off position.

12. The electrical system according to claim 11, wherein the sub-set of the plurality of electrical loads of the vehicle comprises more than one electrical load, the battery saving circuit comprising a plurality of save switches, each save switch corresponding to a different electrical load of the sub-set of electrical loads, each save switch being electrically connected between the corresponding electrical load and the battery for electrically connecting and disconnecting the electrical load from the battery.

13. The electrical system according to claim 11, wherein the battery saving circuit comprises a save switch electrically connected between the battery and at least one electrical load of the sub-set of electrical loads for electrically connecting and disconnecting the at least one electrical load from the battery.

14. The electrical system according to claim 13, wherein the save switch comprises a relay that is electrically connected to the ignition switch such that switching of the ignition switch from the off position to an on position energizes the relay to thereby close the save switch such that the at least one electrical load is electrically connected to the battery.

15. The electrical system according to claim 11, wherein the battery saving circuit comprises a save switch electrically connected between the battery and at least one electrical load of the sub-set of electrical loads for electrically connecting and disconnecting the at least one electrical load from the battery, the save switch having a rating of less than approximately 60 Amperes.

16. The electrical system according to claim 11, wherein the battery saving circuit comprises a save switch electrically connected between the battery and at least one electrical load of the sub-set of electrical loads for electrically connecting and disconnecting the at least one electrical load from the battery, the battery saving circuit further comprising a controller operatively connected to the ignition switch for receiving an electrical signal from the ignition switch that indicates whether the ignitions switch is at least one of on and off, the controller opening and closing the switch based on the received electrical signal.

17. The electrical system according to claim 11, wherein the battery saving circuit comprises a fuse electrically connected between the battery and at least one electrical load of the sub-set of electrical loads.

18. The electrical system according to claim 11, further comprising a fuse box electrically connected between the battery and at least some of the plurality of electrical loads of the vehicle, wherein the battery saving circuit is electrically connected to the fuse box such that the battery saving circuit is electrically connected between the battery and the sub-set of the electrical loads of the vehicle.

19. The electrical system according to claim 11, further comprising a fuse box electrically connected between the battery and at least some of the plurality of electrical loads of the vehicle, wherein the battery saving circuit includes a save switch comprising an electrical input and an electrical output that are configured to be electrically connected to the fuse box in place of a fuse such that the save switch is electrically connected between the battery and at least one electrical load of the sub-set of electrical loads for electrically connecting and disconnecting the at least one electrical load from the battery.

20. The electrical system according to claim 11, wherein the sub-set of the plurality of electrical loads of the vehicle comprises an electrical load that, without the battery saving circuit, at least one of would use intermittent or continuous electrical power from the battery when the ignition switch is in the off position, and would be available to receive electrical power from the battery when the ignition switch is in the off position.
